(19) United States
(12) Patent Application Publication
(10) Pub. No.: US 2026/0021605 A1
(43) Pub. Date: Jan. 22, 2026

(54) Smoothing Tool for Finishing a Joint Filled with a Joint Compound

(71) Applicant: Henkel AG & Co. KGaA, Duesseldorf (DE)

(72) Inventors: Peter Rushe, Duesseldorf (DE); Kai Ruthe-Steinsiek, Duesseldorf (DE); Karsten Wolf, Mettmann (DE)

(21) Appl. No.: 19/196,200

(22) Filed: May 1, 2025

Related U.S. Application Data
(63) Continuation of application No. PCT/EP2023/079399, filed on Oct. 23, 2023.

(30) Foreign Application Priority Data
Nov. 3, 2022 (EP) 22205294.6

(51) Int. Cl. B28B 11/08

(52) U.S. Cl. CPC B28B 11/0845; B28B 11/0809

(57) ABSTRACT

A smoothing tool for finishing a joint filled with a joint compound, is provided having a first plate-shaped joint smoother and a second plate-shaped joint smoother, wherein the first joint smoother and the second joint smoother each have at least one smoothing tip for producing a profile of the joint compound, wherein the first joint smoother has a tenon and the second joint smoother has a mortise, wherein the mortise has a longitudinal axis which lies in a main plane of the second joint smoother or extends parallel thereto, wherein the tenon can assume a basic position and at least one alternative position in the mortise, and wherein, in the basic position, an angle of rotation of the tenon with respect to the longitudinal axis is different from an angle of rotation of the tenon in the alternative position.

### FIELD OF THE INVENTION

The invention relates to a smoothing tool for finishing a joint filled with a joint compound.

### BACKGROUND OF THE INVENTION

DE 10 2015 103 842 A1 discloses a smoothing tool having a first joint smoother and a second joint smoother. The joint smoothers are each designed in the form of an elongated thin plate and have a smoothing tip for producing a profile of the joint compound. Since the smoothing tip of the first joint smoother is different from the smoothing tip of the second joint smoother, the smoothing tool can be used for producing the joint compound with a different profile, as required. For example, the smoothing tip can be convex with a constant radius of curvature so that the profile of the joint compound in the joint takes on a concave shape.

In DE 10 2015 103 842, the joint smoothers are held by a U-shaped holding body, between the U-legs of which the joint smoothers are arranged one above the other in a storage position. From this storage position, the joint smoothers can be swiveled out about a swivel axis that extends between the free ends of the U-legs. In this way, a single joint smoother can be swiveled from the storage position into a use position in order to smooth or remove the joint compound in the joint. The holding body can be used as a handle, which can make smoothing or removing the joint compound easier. However, the holding body can also be disruptive if the space at the joint is very limited, and the holding body hinders optimal positioning of the joint smoother.

DE 298 01 028 U1 discloses a smoothing tool having a first joint smoother and a second joint smoother, each of which has a plurality of smoothing tips. Here, however, the joint smoothers are not connected to one another by a holding body, but are designed as loose pieces. The individual joint smoothers must be held directly in the hand when finishing a joint. The removed joint compound can come into direct contact with the hand or fingers. On the one hand, the removed joint compound can become contaminated so that it can no longer be used for other joints. In addition, the fingers or hand can become so covered in joint compound that a secure hold of the joint smoother and thus its precise guidance can no longer be guaranteed.

EP 0 740 031 A1 also discloses clamping a single joint smoother into a tool holder which functions as a handle. Although this makes direct contact between the hand and the joint compound less likely, an additional component in the form of the tool holder is necessary.

The invention is therefore based upon the object of providing a smoothing tool that is simply constructed and with which the joint can be easily finished. Objects of the invention are achieved by a combination of features as disclosed herein.

### SUMMARY OF THE INVENTION

Exemplary embodiments of the invention can be found in the description, claims, drawings and in the Embodiments below:

Embodiment 1 comprises a smoothing tool (1) for finishing a joint filled with a joint compound, having a first plate-shaped joint smoother (10) and a second plate-shaped joint smoother (40), wherein the first joint smoother (10) and the second joint smoother (40) each have at least one smoothing tip (16, 17, 18, 49, 50, 51) for producing a profile of the joint compound, characterized in that, to achieve a releasable connection between the first joint smoother (10) and the second joint smoother (40), the first joint smoother (10) has a tenon (11) and the second joint smoother (40) has a mortise (41), wherein the mortise (41) has a longitudinal axis (43) which lies in a main plane (44) of the second joint smoother (40) or extends parallel thereto, wherein the tenon (11) can assume a basic position and at least one alternative position in the mortise (41), and wherein, in the basic position, an angle of rotation of the tenon (11) with respect to the longitudinal axis (43) is different from an angle of rotation of the tenon (11) in the alternative position.

Embodiment 2 comprises the smoothing tool (1) according to Embodiment 1, characterized in that the main plane (44) of the second joint smoother (40) substantially coincides with a main plane (13) of the first joint smoother (10) when the tenon (11) is in the basic position, and in that the main plane (44) of the second joint smoother (40) and the main plane (13) of the first joint smoother (10) are substantially at right angles to one another when the tenon (11) is in the alternative position.

Embodiment 3 comprises the smoothing tool (1) according to Embodiment 1 or 2, characterized in that the tenon (11), when it is in the mortise (41), can be rotated from the basic position to the alternative position.

Embodiment 4 comprises the smoothing tool (1) according to one of Embodiments 1 to 3, characterized in that the tenon (11) has a non-round cross-section, and the mortise (41) has a corresponding hollow cross-section which accommodates the cross-section.

Embodiment 5 comprises the smoothing tool (1) according to one of Embodiments 1 to 4, characterized in that a cross-section of the tenon (11) is substantially square.

Embodiment 6 comprises the smoothing tool (1) according to one of Embodiments 1 to 5, characterized in that the tenon (11) has a central blind hole (22).

Embodiment 7 comprises the smoothing tool (1) according to one of Embodiments 1 to 6, characterized in that the tenon (11) can be inserted into the mortise (41) with a linear movement along the longitudinal axis (43) of the mortise (41).

Embodiment 8 comprises the smoothing tool (1), in case of need, according to one of Embodiments 1 to 7, characterized in that locking means are provided which determine an axial position of the tenon (11) in the mortise (41).

Embodiment 9 comprises the smoothing tool (1) according to one of Embodiments 1 to 8, characterized in that the first joint smoother (10) including the tenon (11) is designed in one piece.

Embodiment 10 comprises the smoothing tool (1) according to one of Embodiments 1 to 9, characterized in that the first joint smoother (10) has a flat base plate (14) with a raised central region (20) from which the tenon (11) extends.

Embodiment 11 comprises the smoothing tool (1) according to one of Embodiments 1 to 10, characterized in that the second joint smoother (40) has a flat base plate (45) with a raised central region (46) in which the mortise (41) is arranged.

Embodiment 12 comprises the smoothing tool (1) according to one of Embodiments 1 to 11, characterized in that the first joint smoother (10) and the second joint smoother (40) are made of a plastic containing thermoplastic elastomer components.

Embodiment 13 comprises the smoothing tool (1) according to one of Embodiments 1 to 12, characterized in that the first joint smoother (10) and/or the second joint smoother (40) have a side edge (15, 48) which is beveled at an angle of 5°-75°, preferably at an angle of 45°, thus forming an undercut.

Embodiment 14 comprises the smoothing tool (1) according to one of Embodiments 1 to 13, characterized in that the first joint smoother (10) and/or the second joint smoother (40) have three smoothing tips.

Embodiment 15 comprises the smoothing tool (1) according to one of Embodiments 1 to 14, characterized in that the first joint smoother (10) and/or the second joint smoother (40) have a recessed grip (41, 47).

### BRIEF DESCRIPTION OF THE DRAWINGS

The invention is described in more detail with reference to an exemplary embodiment shown in the drawings, in which:

FIG. 1 is a plan view of a smoothing tool.

FIG. 2 is a perspective view of the smoothing tool of FIG. 1.

FIG. 3 is a perspective view of the smoothing tool of FIG. 1, wherein the first joint smoother and a second joint smoother are separated from one another.

FIG. 4 shows the smoothing tool according to FIG. 2, wherein the first joint smoother and the second joint smoother are rotated by 90° relative to one another.

FIG. 5A is a side view of the smoothing tool of FIG. 1.

FIG. 5B shows a longitudinal section of the smoothing tool of FIG. 1 taken along the line V-V in FIG. 1.

### DETAILED DESCRIPTION OF THE INVENTION

According to the invention, there is provision that, to achieve a releasable connection between the first joint smoother and the second joint smoother, the first joint smoother have a tenon and the second joint smoother have a mortise. The mortise has a longitudinal axis which lies in a main plane of the second joint smoother or extends parallel thereto, wherein the tenon can assume a basic position and at least one alternative position in the mortise. In the basic position, an angle of rotation of the tenon with respect to the longitudinal axis is different from an angle of rotation of the tenon in the alternative position.

By connecting the tenon and the mortise, the second joint smoother can be used, for example, as a handle for the first joint smoother, with the smoothing tip of which the joint with the joint compound filled therein can be finished. This means that no separate handle or tool holder is necessary to reduce the risk of direct contact between the joint compound and the hand. Since the tenon in the mortise can assume different angle of rotation positions, it is possible to align the second joint smoother, which functions as a handle, with respect to the first joint smoother in such a way that the handling of the first joint smoother is simplified or, in confined spaces, the correct positioning of the first joint smoother on the joint is not hindered. If the space available does not allow the use of the second joint smoother as a handle, the second joint smoother can be separated from the first joint smoother thanks to the releasable connection between the tenon and the mortise. In this case, the first joint smoother is guided directly by hand, but at the expense of a smaller distance between the hand/finger and the joint compound.

Conversely, the first joint smoother can also be used as a handle for the second joint smoother in order to be able to use the smoothing tip of the second joint smoother. It is therefore preferred that the smoothing tip of the first joint smoother differ from the smoothing tip of the second joint smoother, so that different smoothing tips can be used in the smoothing tool according to the invention, wherein one of the joint smoothers is used as a handle in each case.

In one exemplary embodiment, the main plane of the second joint smoother substantially coincides with a main plane of the first joint smoother when the tenon is in the basic position. In this case, the two plate-shaped joint smoothers lie in a common plane. The main plane of the second joint smoother and the main plane of the first joint smoother may be substantially at right angles to one another when the tenon is in the alternative position.

In one exemplary embodiment, the main planes of the two joint smoothers coincide exactly in the basic position of the tenon. In another exemplary embodiment, the main planes of the two joint smoothers are exactly at right angles when the tenon is in the alternative position.

In one exemplary embodiment, the tenon, when it is in the mortise, can be rotated from the basic position to the alternative position. In this exemplary embodiment, it is not necessary to separate the connection between the tenon and the mortise in order to move the tenon from one position to the other. This facilitates the handling of the smoothing tool. The torque required for rotation is preferably so high that it is not achieved during normal use of the smoothing tool. The necessary torque should, however, be able to be provided by human hands alone, i.e., without additional tools.

The tenon may have a non-round cross-section. Preferably, the mortise has a corresponding hollow cross-section which accommodates the cross-section. In one exemplary embodiment, the cross-section of the tenon is substantially square, while the hollow cross-section of the mortise is also substantially square. The square cross-section of the tenon and/or the square hollow cross-section of the mortise may have rounded corners.

The square cross-section of the tenon and the square hollow cross-section of the mortise define four angles of rotation, each spaced 90° apart, with which the tenon can be in the mortise with respect to the longitudinal axis of the mortise. For example, it is possible to rotate the basic position and the alternative position by 90°, 180°, or 270° relative to one another. The square cross-section and the square hollow cross-section ensure that the connection between the tenon and the mortise (when used as intended) is rotationally fixed, which is an important prerequisite for one of the two joint smoothers to be able to be guided precisely by the other joint smoother, which functions as a handle.

Various measures can be taken to ensure that the torque required to rotate the tenon in the mortise from the basic position to the alternative position when necessary is not too great, and at the same time the connection between the tenon and the mortise is secured against rotation when the smoothing tool is used as intended. For example, the material of the tenon and/or mortise should be selected to have a certain elasticity so that, for example, the square cross-section of the tenon can be rotated within the square hollow cross-section of the mortise. The extent to which the corners of the square cross-section or the square hollow cross-section are rounded also plays a role. Alternatively, or additionally, the tenon can have a central blind hole, which can influence the dimensional stability of the tenon. If only a small wall thickness remains between the central blind hole and the square (outer) cross-section, the tenon can easily deform elastically when rotated within the mortise.

Preferably, the tenon can be inserted into the mortise with a linear movement along the longitudinal axis of the mortise. It is therefore a plug-in connection between the tenon and the mortise. In one exemplary embodiment, the connection between the tenon and the mortise can be released in such a way that the tenon is pulled out of the mortise by a linear movement along the longitudinal axis—opposite to the movement for establishing the connection. Preferably, locking means are provided which determine an axial position of the tenon in the mortise. When inserting or removing the tenon, certain locking forces must be overcome. The locking forces are preferably set so that the connection between the tenon and the mortise is not broken when the smoothing tool is used as intended. However, it should be possible to separate the second joint smoother from the first joint smoother by hand. Therefore, in one exemplary embodiment, no separate tool is required to pull the tenon out of the mortise or to press the tenon into the mortise.

The first joint smoother including the tenon can be made in one piece. The first joint smoother can be an injection-molded plastic part. The plastic can be a plastic mixture of a polyolefin and a thermoplastic elastomer (TPE). The mass fraction of the thermoplastic elastomer is preferably in the range of 10 to 30%. The preferred polyolefin is LDPE (low density polyethylene), which is easy to process. In one exemplary embodiment, the plastic mixture comprises 80% LDPE and 20% TPE. Using the plastic mixtures described above, a smoothing tool can be provided in which, on the one hand, the connection between the tenon and mortise and, on the other, the smoothing tips of the joint smoother have a balanced relationship between dimensional stability and elasticity.

The second joint smoother can also be made in one piece. It can also be an injection-molded plastic part, wherein the same materials can be used as for the first joint smoother. Preferably, the first joint smoother and the second joint smoother are made of the same material.

In one exemplary embodiment, the first joint smoother has a flat base plate with a raised central region from which the tenon extends. The second joint smoother can also have a flat base plate with a raised central region, wherein the mortise is now housed in the central region. As a result of the raised central regions, the two joint smoothers have increased rigidity in the region of the connection between the tenon and the mortise.

The first joint smoother and/or the second joint smoother can have side edges which are beveled at an angle of 5°-75°, preferably at an angle of 45°, thus forming an undercut. This allows the joint compound to be precisely removed or smoothed out.

The first joint smoother and/or the second joint smoother can have a recessed grip, which improves the grip and thus the handling of the joint smoother, regardless of whether the respective joint smoother is guided directly or indirectly over the other joint smoother, which functions as a handle.

The first base body and/or the second joint smoother can have three smoothing tips. This means that the individual joint smoother can also be used without the other joint smoother for producing different profiles on the joint compound.

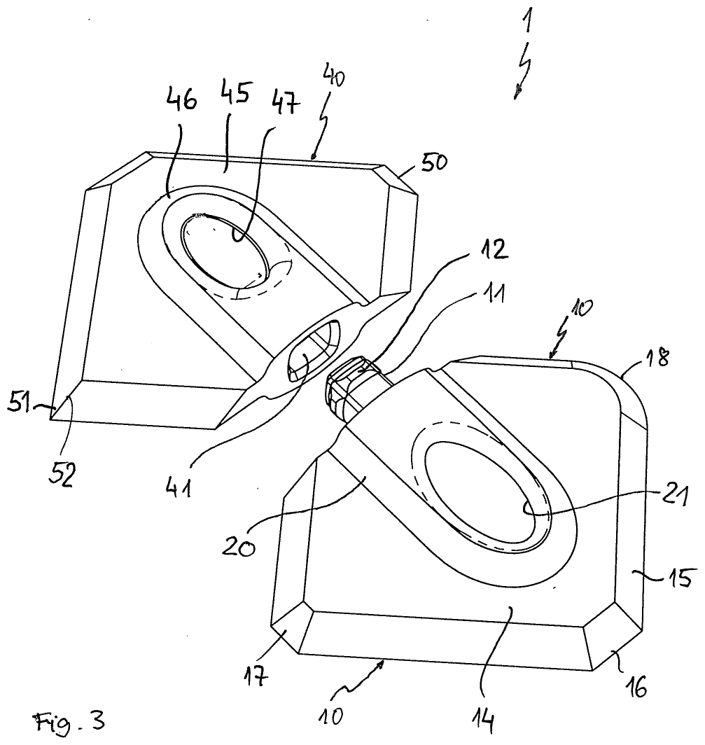

The figures show a smoothing tool, which is denoted as a whole by 1. The smoothing tool 1 can be used to smooth out a joint compound that has previously been applied into or onto a joint—for example, with a cartridge gun. The smoothing tool 1 comprises a first joint smoother 10 and a second joint smoother 40. As can be seen in particular from FIG. 3, the first joint smoother 10 and the second joint smoother 40 are two separate components which can be connected to and separated from one another.

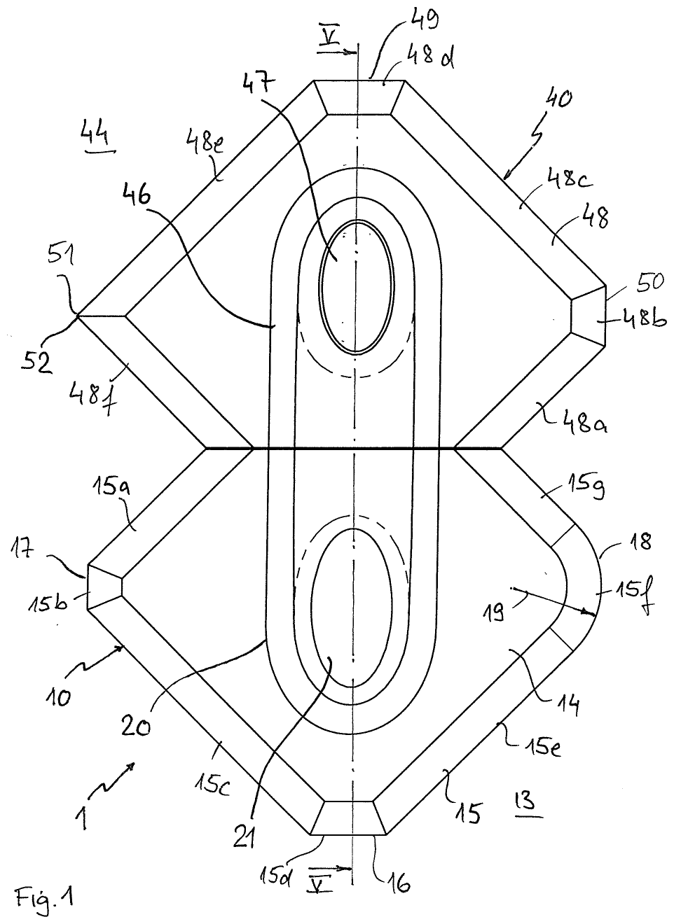

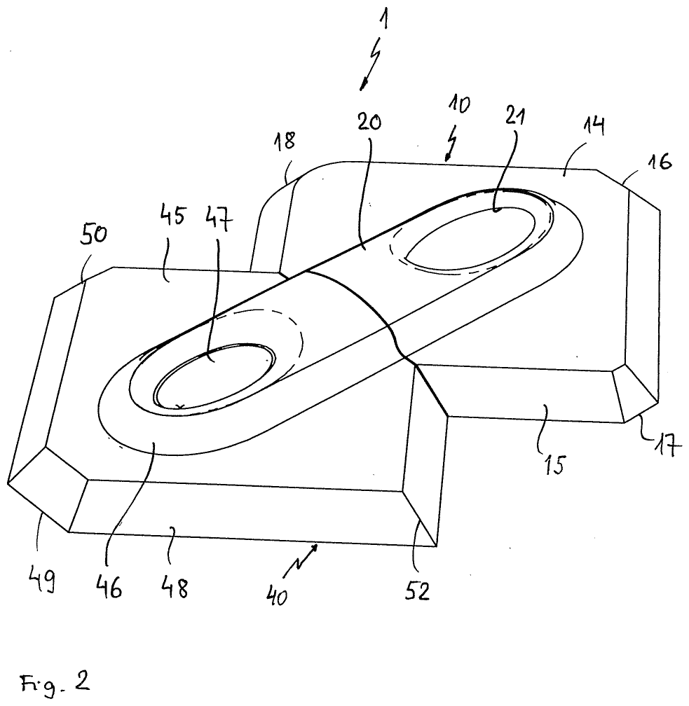

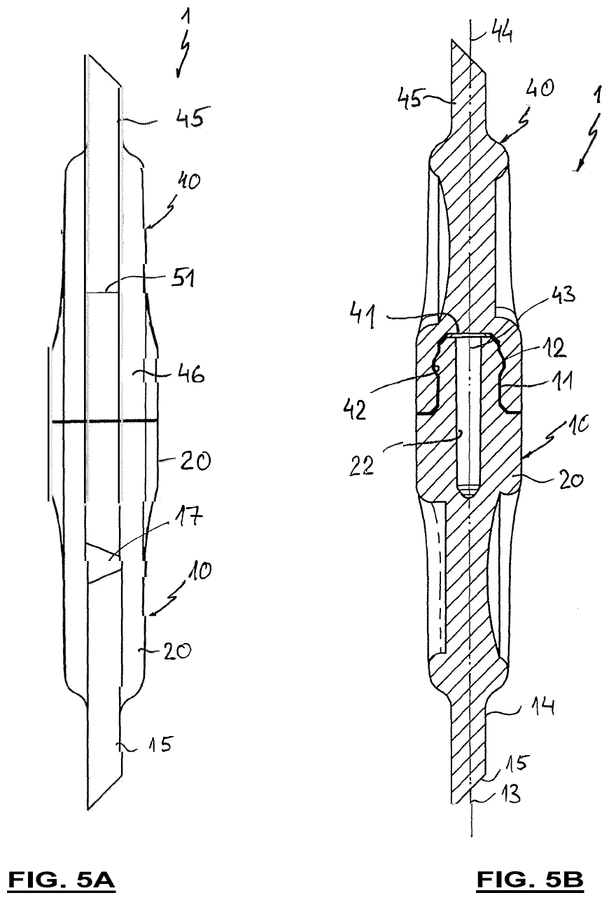

The joint smoother 10 has a tenon 11 which can be inserted into a mortise 41 of the second joint smoother 40. The tenon 11 has a square cross-section with rounded corners. In addition, the tenon 11 has locking means in the form of a locking lug 12 on each outer edge of the square cross-section. In the connected state of the tenon 11 and the mortise 41, the locking lug 12 engages in a locking groove 42 of the mortise 41 (see FIG. 5B, which shows a longitudinal section along the line V-V in FIG. 1). The interaction of the locking lug 12 and the locking groove 42 prevents the tenon 11 from accidentally slipping out of the mortise 41. In other words, a certain locking force must be overcome in order to pull the tenon 11 out of the mortise 41.

Except in FIG. 3, the figures show the first joint smoother 10 and the second joint smoother 40 in a connected state. In this connected state, the tenon 11 is in the mortise 41. The tenon 11 can assume various positions in the mortise 41, which differ in an angle of rotation with respect to a longitudinal axis 43 of the mortise 41. As is clear from FIG. 5B, the longitudinal axis 43 lies in a main plane 44 of the second joint smoother 40. Both the longitudinal axis 43 and the main plane 44 are shown in FIG. 5B by the dash-dotted line there. In the illustration in FIG. 1, the main plane 44 corresponds to the drawing plane of FIG. 1.

In a basic position, the tenon 11 is inserted into the mortise 41 in such a way that a main plane 13 of the first joint smoother 10 coincides with the main plane 44 of the second joint smoother 40. The main plane 13 of the first joint smoother 10 and the main plane 44 of the second joint smoother 40 lie in the same plane, which, as already explained above, corresponds to the drawing plane in the illustration of FIG. 1 (see also the dash-dotted line in FIG. 5B).

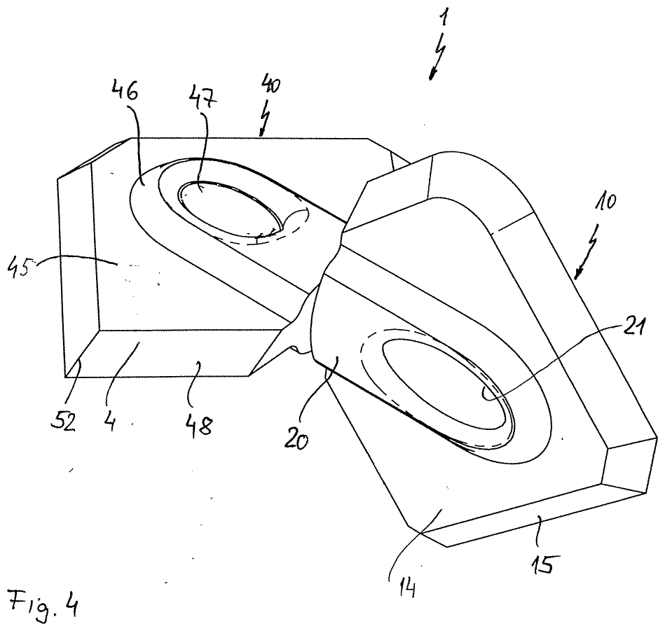

In addition, the tenon 11 can assume an alternative position in the mortise 41, which leads to the configuration shown in FIG. 4. In the alternative position, the main plane 13 of the first joint smoother 10 and the main plane 44 of the second joint smoother are rotated by 90° to one another.

The first joint smoother 10 has a flat base plate 14 with a circumferential side edge 15 which is beveled at an angle of 45° to the main plane 13. The thickness of the base plate 14 is preferably only a few millimeters (for example, 3 to 8 mm, preferably 4 to 6 mm). The maximum extension of the base plate 14 in one direction within the main plane 13 can be 40 to 100 mm.

The side edge 15 has different edge portions, wherein a smoothing tip 16 of the first joint smoother 10 is formed by three edge portions 15c, 15d, and 15e (see FIG. 1). The portions 15c and 15e are each straight and form an angle of 90°.

Between these mutually perpendicular edge portions 15c, 15e, the edge portion 15d is arranged, which forms an angle of 45° to each of the edge portions 15c, 15e. The smoothing tip 16 can be used to smooth the joint compound of a joint running along two mutually perpendicular surfaces (for example, the floor and wall of a bathroom). The profile of the joint compound that can be produced with this smoothing tip 16 has a correspondingly straight surface inclined at 45° to the floor or wall. The length of the edge portion 15d can, for example, be 10 mm.

In addition to the smoothing tip 16, the first joint smoother 10 has two further smoothing tips 17 and 18, wherein the smoothing tip 17 is formed by the edge portions 15a, 15b, and 15c, and the smoothing tip 18 is formed by the edge portions 15e, 15f, and 15g. The smoothing tip 17 differs from the smoothing tip 16 essentially only in the length of the edge portion, which lies between the two mutually perpendicular outer edge portions of the respective smoothing tip 16, 17. The length of the edge portion 15b can, for example, be 6 mm, so that the finishing with this smoothing tip 17 leads to a smoothed joint compound with a joint compound width that is smaller than the joint compound width that can be achieved with the smoothing tip 16. With the smoothing tip 18, in which an edge portion 15f has a constant radius of curvature 19 (for example, a radius of 12 mm), a profile for the joint compound can be produced which adheres tangentially to the wall and floor. The profile of the joint compound is concave. The basic shape of the base plate 14 is square, apart from the oblique flattening in the region of the tenon 11.

In addition, the first joint smoother 10 has a raised central region 20 into which a recessed grip 21 is incorporated. The tenon 11 extends outwards from the raised central region 20 of the base plate 14. The tenon 11 lies in the main plane 13 of the first joint smoother 10.

The second joint smoother 40 has a comparable structure with a flat base plate 45 and a raised central region 46. Here too, the raised central region 46 is provided with a recessed grip 47. The thickness of the base plate 45 is 3 to 8 mm. A circumferential side edge 48 can be divided into a plurality of edge portions 48a, 48b, 48c, 48d, 48e, 48f. The length of the edge portion 48d differs from the lengths of the edge portions 15b, 15d, so that a smoothing tip 49, which is formed by the portions 48c, 48d, and 48e, can in turn be used for producing a joint compound with different joint compound widths. In addition to the smoothing tip 49, the second joint smoother 40 has two further smoothing tips 50, 51. The smoothing tip 51 is formed only by the perpendicular edge portions 48e, 48f that meet at a corner point 52.

If the smoothing tip 16 is to be used to finish a joint filled with a joint compound, the second joint smoother 40 can be used as a handle in the connected state. The handle (or the joint smoother 40) can accordingly make the finishing easier. In particular, the handle can be used to increase the distance between the joint compound and the hand with which the smoothing tool 1 is guided. In special situations (space is confined, access to the joint is difficult), it can be advantageous if the joint smoother which functions as a handle is rotated by 90° with respect to the first joint smoother. In particularly confined spaces or when access to the joint is particularly poor, it may also be advantageous to use only the first joint smoother 10 and to forgo the advantages of the second joint smoother 40 as a handle. For this purpose, the second joint smoother 40 can be released from the first joint smoother 10 by pulling the tenon 11 out of the mortise 41.

In a similar manner to the smoothing tip 16, the smoothing tip 49 of the second joint smoother can also be used with the aid of a handle, wherein the first joint smoother 10 now functions as a handle. Here too, depending upon the given situation (space conditions, access to the joint), the joint smoother 10 acting as a handle can be rotated by 90, 180, or 270° with respect to the second joint smoother 40 or can be completely released.

In order for the tenon 11 to be able to rotate in the mortise 41, the material of the one-piece joint smoother 10 or the material of the also one-piece joint smoother 40 must have a certain elasticity. It has proven advantageous to use a plastic mixture comprising polyethylene and a thermoplastic elastomer for the material of the two joint smoothers 10, 40. With such a plastic mixture, a certain flexibility of the side edges 15, 48 of the joint smoothers 10, 40 can also be adjusted, which can compensate for unevenness during the finishing of the joint.

In addition to the choice of material, the elasticity or dimensional stability of the tenon 11 can also be adjusted by a blind hole 22, which is arranged centrally with respect to the cross-section of the tenon 11. If only a small wall thickness remains between the outer edge of the cross-section of the tenon 11 and the blind hole 22, the tenon 11 can be deformed more easily if the two joint smoothers 10, 40 are rotated towards one another in the connected state of the tenon 11 and the mortise 43.

The smoothing tool 1 according to the invention offers various application options. The joint smoothers 10, 40 can be used alternately as a handle or tool holder for the other joint smoother 40, 10. The joint smoother which functions as a handle can be rotated relative to the other joint smoother. In addition, the joint smoothers 10, 40 can be separated from one another. The invention thus provides a simply constructed and very flexible smoothing tool.

### LIST OF REFERENCE NUMBERS

1 Smoothing tool
10 First joint smoother
11 Tenon
12 Locking lug
13 Main plane
14 Base plate
15 Side edge (15a to 15g edge portions)
16 Smoothing tip
17 Smoothing tip
18 Smoothing tip
19 Radius of curvature
20 Central region
21 Recessed grip
22 Blind hole
40 Second joint smoother
41 Mortise
42 Locking groove
43 Longitudinal axis
44 Main plane
45 Base plate
46 Central region
47 Recessed grip
48 Side edge (48a to 48f edge portions)
49 Smoothing tip
50 Smoothing tip
51 Smoothing tip
52 Corner point

What is claimed is:

1. A smoothing tool for finishing a joint filled with a joint compound, having a first plate-shaped joint smoother and a second plate-shaped joint smoother, wherein the first joint smoother and the second joint smoother each have at least one smoothing tip for producing a profile of the joint compound, wherein, to achieve a releasable connection between the first joint smoother and the second joint smoother, the first joint smoother has a tenon and the second joint smoother has a mortise, wherein the mortise has a longitudinal axis which lies in a main plane of the second joint smoother or extends parallel thereto, wherein the tenon can assume a basic position and at least one alternative position in the mortise, and wherein, in the basic position, an angle of rotation of the tenon with respect to the longitudinal axis is different from an angle of rotation of the tenon in the alternative position.

2. The smoothing tool according to claim 1, wherein the main plane of the second joint smoother substantially coincides with a main plane of the first joint smoother when the tenon is in the basic position, and in that the main plane of the second joint smoother and the main plane of the first joint smoother are substantially at right angles to one another when the tenon is in the alternative position.

3. The smoothing tool according to claim 1, wherein the tenon, when it is in the mortise can be rotated from the basic position to the alternative position.

4. The smoothing tool according to claim 1, wherein the tenon has a non-round cross-section, and the mortise has a corresponding hollow cross-section which accommodates the cross-section.

5. The smoothing tool according to claim 1, wherein a cross-section of the tenon is substantially square.

6. The smoothing tool according to claim 1, wherein the tenon has a central blind hole.

7. The smoothing tool according to claim 1, wherein the tenon can be inserted into the mortise with a linear movement along the longitudinal axis of the mortise.

8. The smoothing tool according to claim 1, wherein locking means are provided which determine an axial position of the tenon in the mortise.

9. The smoothing tool according to claim 1, wherein the first joint smoother including the tenon is designed in one piece.

10. The smoothing tool according to claim 1, wherein the first joint smoother has a flat base plate with a raised central region from which the tenon extends.

11. The smoothing tool according to claim 1, wherein the second joint smoother has a flat base plate with a raised central region in which the mortise is arranged.

12. The smoothing tool according to claim 1, wherein the first joint smoother and the second joint smoother are made of a plastic containing thermoplastic elastomer components.

13. The smoothing tool according to claim 1, wherein the first joint smoother and/or the second joint smoother have a side edge which is beveled at an angle of 5°-75°, at an angle of 45°, thus forming an undercut.

14. The smoothing tool according to claim 1, wherein the first joint smoother and/or the second joint smoother have three smoothing tips.

15. The smoothing tool according to claim 1, wherein the first joint smoother and/or the second joint smoother have a recessed grip.
